(19) United States
(12) Patent Application Publication
(10) Pub. No.: US 2024/0273401 A1
(43) Pub. Date: Aug. 15, 2024

(54) PRIVACY PRESERVING TRANSFER LEARNING

(71) Applicant: Google LLC, Mountain View, CA (US)

(72) Inventors: Wei Huang, Kirkland, WA (US); David V. Guthrie, San Francisco, CA (US); Kumar Rishabh, Redmond, WA (US); Lixue Zhang, Fremont, CA (US); Chenwei Yue, Sunnyvale, CA (US)

(21) Appl. No.: 18/169,011

(22) Filed: Feb. 14, 2023

(51) Int. Cl. G06N 20/00; G06F 21/62

(52) U.S. Cl. CPC G06N 20/00; G06F 21/6218

(57) ABSTRACT

Methods, systems, and apparatus, including computer programs encoded on a computer storage medium, for training and using machine learning models to predict data in privacy preserving manners are described. In one aspect, a method includes receiving, from a client device of a user, a digital component request including one or more contextual signals that describe an environment in which a selected digital component will be presented. The contextual signals are provided as input to a trained machine learning model that is trained to output, based on input contextual signals, predicted data about the user. The trained machine learning model is trained using a set of aggregated data including, for each of a set of aggregation keys, aggregated data for a plurality of users having electronic resource views that match the aggregation key. The predicted data about the user is received as an output of the trained machine learning model.

### TECHNICAL FIELD

This specification is related to machine learning and data privacy.

### BACKGROUND

Machine learning is a type of artificial intelligence that aims to teach computers how to learn and act without necessarily being explicitly programmed. More specifically, machine learning is an approach to data analysis that involves building and adapting models, which allow computer executable programs to “learn” through experience. Machine learning involves design of algorithms that adapt their models to improve their ability to make predictions. This can be done by first training a machine learning model using historical data (training data) for which the outcome (label) is known, which is referred to as supervised learning. The computer may identify rules or relationships during the training period and learn the learning parameters of the machine learning model. Then, using new inputs, the machine learning model can generate a prediction based on the identified rules or relationships.

Data security and user privacy is vital in systems and devices connected to public networks, such as the Internet. The enhancement of user privacy has led many developers to change the ways in which user data is handled. For example, some browsers are planning to deprecate the use of third-party cookies.

### SUMMARY

This document relates to transfer learning techniques for training a machine learning model that outputs predictions regarding users in ways that protect the privacy of the users and their data. In general, one innovative aspect of the subject matter described in this specification can be embodied in methods including the operations of receiving, from a client device of a user, a digital component request including one or more contextual signals that describe an environment in which a selected digital component will be presented; providing the one or more contextual signals as input to a trained machine learning model that is trained to output, based on input contextual signals, predicted data about the user, wherein the trained machine learning model is trained using a set of aggregated data comprising, for each of a set of aggregation keys, aggregated data for users having electronic resource views that match the aggregation key; receiving, as an output of the trained machine learning model, the predicted data about the user; selecting one or more digital components based on the predicted data about the user; and sending, to the client device, the one or more digital components for presentation at the client device. Other implementations of this aspect include corresponding apparatus, systems, and computer programs, configured to perform the aspects of the methods, encoded on computer storage devices.

These and other implementations can each optionally include one or more of the following features. In some aspects, the predicted data about the user includes at least one of (i) one or more interests of the user or (ii) one or more attributes of the user.

In some aspects, the one or more contextual signals include (i) at least a portion of a resource locator for an electronic resource, (ii) a type of the client device, or (iii) a geographic location of the client device.

In some aspects, each aggregation key includes at least one contextual signal and/or at least one topic of interest.

In some aspects, the at least one contextual signal includes (i) at least a portion of a resource locator for an electronic resource, (ii) a type of device, or (iii) a geographic location.

Some aspects can include generating the set of aggregated data, including, for each aggregation key, identifying the plurality of users having electronic resource views that match the aggregation key, identifying a set of data for each of the users, and aggregating the set of data for each of the users.

In some aspects, the set of data for each user includes (i) one or more interests of the user or (ii) attributes of the user. Generating the set of aggregated data can include identifying the set of aggregation keys, including selecting, for inclusion in the set of aggregation keys, only aggregation keys for which the users satisfy a k-anonymity condition. Some aspects include applying differential privacy to the set of aggregated data by adjusting a count of users in the plurality of users for one or more aggregation keys.

Some aspects include training the trained machine learning model using a transfer learning technique. Training the trained machine learning model can include adding the set of aggregated data as labels or features of the trained machine learning model.

Particular embodiments of the subject matter described in this specification can be implemented so as to realize one or more of the following advantages. Transfer learning techniques are used to leverage data about a set of users for which rich data is available to predict data about other users (for which more limited or no data is available) of electronic resources (e.g., websites) in ways the preserve data privacy of the users, e.g., by preventing the training system from accessing or learning anything the set of users. Instead, the data is aggregated based on contextual keys and data privacy techniques (e.g., k-anonymity and/or differential privacy techniques) are applied to the aggregated data to ensure that data about individual users is inaccessible. Therefore, using the techniques described in this document, users can receive content that is likely to be relevant to the user without compromising any user's privacy.

Using transfer learning, machine learning models are trained to output predictions about unknown users of electronic resources, which can then be used to select and/or customize content (e.g., digital components) for the users. The machine learning techniques combined with the aggregation techniques described in this document allow for the selection and distribution of content that is relevant to users based on a limited set of signals, such as a resource locator for the electronic resource with which the content is presented, a type of device at which the content will be presented, and/or coarse location information (e.g., country) for the device, by leveraging richer data about a set of users for which such data is available. By using the trained machine learning models, the efficiency of transmitting content to client devices is improved as content that is not relevant to a particular user need not be transmitted. In addition, third-party cookies are not required thereby avoiding the storage of third-party cookies, improving memory usage, and reducing the amount of bandwidth that would otherwise be consumed by transmitting the cookies.

The use of transfer learning techniques described in this document also reduces the amount of data that needs to be collected and stored. For example, transfer learning utilized knowledge obtained from one domain for use in another domain such that data from the other domain does not have to be collected, stored, or processed. This reduces data storage requirements and consumed bandwidth.

Historically, third-party cookies (e.g., cookies from a different domain than the resource being rendered by a client device) have been used to collect data from client devices across the Internet. However, some browsers and device platforms block the use of third-party cookies and third-party cookies are increasingly being removed from use, thereby preventing the collection of data using third party cookies. This creates a challenge when attempting to utilize collected data to make inferences, segment data, or otherwise utilize data to enhance online browsing experiences, e.g., by selecting content relevant to users based on the data collected using third party cookies. In other words, without the use of third-party cookies, much of the data previously collected is no longer available, which prevents computing systems from being able to use that data to predict interests or attributes of users based on activities performed by the users at particular web pages or other resources, to enhance the online experience for users, and/or to present relevant content to users.

The techniques described herein can solve hurdles that may arise from the eradication of third-party cookies. For example, transfer learning techniques are used to train machine learning models based on data regarding known users (e.g., users that are signed into a website or application) such that the trained machine learning models can predict data about unknown users without using third-party cookies.

Using the techniques described in this document, interests and/or attributes of users can be predicted without transmitting third-party cookies across a public network, e.g., the Internet. By doing so, user privacy is protected, network bandwidth is reduced, and computational resources of the server that would receive and process the cookies is reduced.

Machine learning models can be used to predict data about users (e.g., interests, attributes, etc.) based on a limited set of signals received in a request for a digital component. As the machine learning models operate on a limited set of data received from client devices art request time, such machine learning models can be executed by content platforms rather than by the client device of the user, which, since content platforms include more computational resources, enables more complex machine learning models (e.g., neural networks having greater numbers of layers and/or neurons) to be used relative to those that can effectively run on client devices. In addition, this structure increases the speed at which the machine learning models are executed, which is critical in selecting and presenting additional content (e.g., digital components) with primary content of web pages, applications, or other electronic resources.

Delays in providing content, e.g., digital components, in response to requests can result in page load errors at the client devices or cause portions of an electronic resource to remain unpopulated even after other portions of the electronic resource are presented at the client devices. Also, as the delay in providing the digital component to the client device increases, it is more likely that the electronic resource will no longer be presented at the client device when the digital component is delivered to the client device, thereby negatively impacting a user's experience with the electronic resource. Further, delays in providing the digital component can result in a failed delivery of the digital component, for example, if the electronic resource is no longer presented at the client device when the digital component is provided.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which transfer machine learning models are trained and used to distribute digital components to client devices in a privacy preserving manner.

FIG. 2 is a flow diagram of an example process for aggregating data and training a transfer machine learning model using the aggregated data.

FIG. 3 is a flow diagram of an example process for selecting a digital component using a machine learning model and providing the digital component for presentation at a client device.

FIG. 4 is a block diagram of an example computer system.

Like reference numbers and designations in the various drawings indicate like elements.

### DETAILED DESCRIPTION

In general, this document describes systems and techniques for training and using machine learning models to predict data about users in privacy preserving manners. The predicted data can then be used to select digital components to distribute to client devices for presentation to users. Transfer machine learning techniques can be used to train the machine learning models based on data for a set of users for which rich data is available and then used to predict data about users for which no or little data is available.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

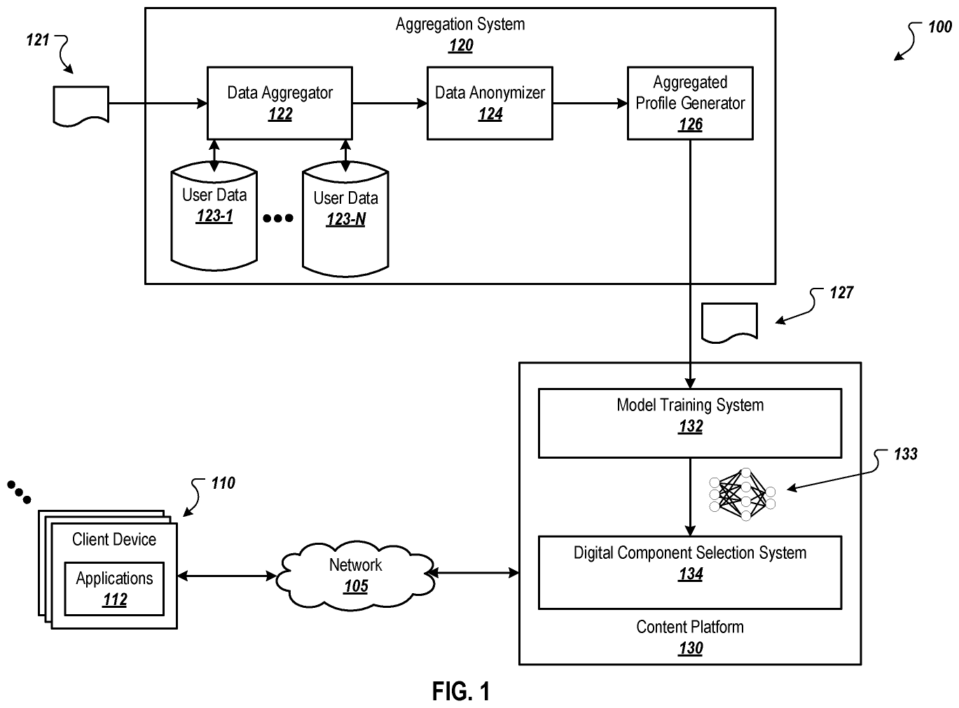

FIG. 1 is a block diagram of an example environment 100 in which transfer machine learning models are trained and used to distribute digital components to client devices 110 in a privacy preserving manner. The environment 100 includes a data communication network 105, such as a local area network (LAN), a wide area network (WAN), the Internet, a mobile network, or a combination thereof. The data communication network 105 connects client devices 110 with a content platform 130. Although not shown in FIG. 1, the network 105 can also connect the content platform 130 with an aggregation system 120.

A client device 110 is an electronic device that is capable of communicating over the network 105. Example client devices 110 include personal computers, server computers, mobile communication devices, e.g., smart phones and/or tablet computers, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including, a wearable device (e.g., watch or glasses), a smart phone, a speaker device, a tablet device, or another hardware device. A client device can also include a digital media device, e.g., a streaming device that plugs into a television or other display to stream videos to the television, a gaming device, or a virtual reality system.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

A client device 110 includes applications 112, such as web browsers and/or native applications, to facilitate the sending and receiving of data over the network 105. A native application is an application developed for a particular platform or a particular device (e.g., mobile devices having a particular operating system) Operations described as being performed by the client device 110 can be performed by the application 112 and operations described as being performed by the application 112 can be performed by another component of the client device 110. A client device 110 can include many different types of applications.

The applications 112 can present electronic resources, e.g., web pages, application pages, or other application content, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of this document, a resource can refer to a web page, application page, application content presented by a native application, electronic document, audio stream, video stream, or other appropriate type of electronic resource with which a digital component can be presented.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 can generate a digital component request that requests a digital component for presentation in the digital component slot. In some implementations, the digital component slot and/or the resource can include code (e.g., scripts) that cause the application 112 to request a digital component. The application 112 can send the digital component request to the content platform 130.

A digital component request sent by the application 112 can include contextual data. The contextual data can describe the environment in which a selected digital component will be presented. The contextual data can include, for example, a resource locator for a resource (e.g., website or native application) with which the selected digital component will be presented, coarse location information indicating a general location of the client device 110 that sent the digital component request (e.g., the country or state in which the client device 110 is located), a type of the client device 110 (e.g., laptop computer, smartphone, gaming device, etc.), a spoken language setting of the application 112 or client device 110, the number of digital component slots in which digital components will be presented with the resource, the types of digital component slots, and other appropriate contextual information. The resource locator can be in the form of a Universal Resource Locator (URL), a Uniform Resource Identifier (URI), network address, domain name, or other appropriate resource locator.

The digital component request may not include data that can be used to identify the user. For example, the digital component request may not include a cookie (e.g., a third-party cookie), user identifier, IP address, or other identifying information.

The content platform 130, which can be implemented as one or more computers in one or more locations, is configured to distribute digital components to client devices 110, e.g., in response to digital component requests received from the client devices 110. The content platform 130 includes a model training system 132 and a digital component selection system 134, both of which can be implemented as one or more computers in one or more locations.

As described in more detail below, the model training system 132 is configured to train machine learning models 133 to predict data about users based at least in part on the contextual data received in digital component requests. The machine learning models can include deep learning models (e.g., neural networks), decision trees, regression models, and/or other appropriate types of machine learning models. The model training system 132 can also train machine learning models 133 to output scores for digital components, e.g., based on the predicted user data, the contextual data, historical performance data for the digital components (e.g., user interaction rates, conversion rates, etc.), and/or other appropriate data. The model training system 132 provides the machine learning models 133 to the digital component selection system 134 for use in selecting digital components to provide to client devices 110 in response to the digital component requests.

The digital component selection system 134 is configured to use a machine learning model 133 to predict data about users based on contextual data of digital component requests. The digital component selection system 134 can identify, in a digital component request, contextual data that is appropriate for the machine learning model 133, e.g., contextual data for which the machine learning model 133 is trained to use in predicting the user data. The digital component selection system 134 can provide the identified contextual data as input to the machine learning model 133. The digital component selection system 134 can receive, as an output of the machine learning model 133, predicted data about the user from which the digital component request was received. The predicted data can include predicted interests of the user (e.g., topics of interest) and/or attributes of the user (e.g., demographic attributes or other characteristics of the user).

For example, the machine learning model 133 can be trained to output a score for each label of a set of labels. Each label can correspond to a topic of user interest or a user attribute. The machine learning model 133 can be trained to output higher scores when it is more likely that the user has interest in the topic or has the attribute and lower scores if it is less likely that the user has interest in the topic or does not have the attribute.

The digital component selection system 134 can then select a digital component to send to the client device 110 for presentation to a user based on the predicted user data. The digital component selection system 134 can use another machine learning model 133 to output scores for the digital components and then select a digital component based on the scores. In another example, the digital component selection system 134 can be configured to select a digital component based on a set of rules. In this example, the set of rules can specify for which contextual data or combinations of contextual data each digital component is eligible for selection. For example, a first digital component may only be eligible to be selected and provided to client devices 110 in a particular country and a second digital component may not be eligible for display with electronic resources having particular types of content.

Once selected, the digital component selection system 134 can provide the selected digital component to the application 112 from which the digital component was received. The application 112 can then present, e.g., display, the digital component to the user. Using the machine learning model(s) 133 in this way increases the likelihood that relevant digital components that include content of interest to the user is provided to the user, although the content platform 130 does not have access to the identity of the user.

The aggregation system 120, which can be implemented as one or more computers in one or more locations, is configured to aggregate user data and to generate, based on the aggregated user data, aggregated profiles for aggregation keys for use in training machine learning models that predict data about users. The aggregation system 120 includes a data aggregator 122, a data anonymizer 124, and an aggregated profile generator 126.

In general, an aggregated profile includes aggregated data, including aggregated user data, for an aggregation key that is based on a set of signals, e.g., a set of contextual signals of a set of topics of interest. For example, a context-based aggregation key can include one or more contextual signals, such as one or more particular resource locators, one or more particular geographic locations, and/or one or more particular types of devices. In this example, the context-based aggregation key can be in the form<URL, Location, Device Type>. Other appropriate contextual signals can also be used. In a particular example, a context-based aggregation key can be <example.com/flowers, Canada, smartphone>. The aggregated profile for this key would include data related to users that have visited example.com/flowers from smartphones located in Canada.

In another example, a topics-based aggregation key can be in the form of <Topic1, Topic2, . . . TopicN>. A topics-based aggregation key can include N topics, where Nis any integer greater than zero. In a particular example, a topics-based aggregation key can be <flowers, gardening, and baking>. The aggregated profile for this key would include data related to users that have, as a topic of interest of the user, at least one of these topics or, in some cases, must have all three topics. Aggregation keys can include a combination of contextual signals, topics, and/or other appropriate signals.

Aggregation keys can be configured by various entities, such as the content platform 130 for use in training machine learning models 133 that are used for selecting and distributing digital components. The content platform 130 can provider, to the aggregation system 120, configuration data 121 that defines the aggregation keys for which aggregated profiles are to be generated by the aggregation system 120. The configuration data 121 can also define, for each aggregation key, the types of data to include in an aggregated profile for the aggregation key. For example, the configuration data 121 can specify that the aggregated profile for an aggregation key is to include the top N topics of interests of users for which data is aggregated for the aggregation key, where N is any integer greater than zero. In another example, the configuration data 121 can specify that the aggregated profile for an aggregation key is to include, for each of multiple user attributes, a count of the number of users or a percentage of the users for which data is aggregated for the aggregation key that have that user attributes. Many combinations of data types can be included in an aggregated profile.

The data aggregator 122 is configured to aggregate user data from one or more user data sources 123, e.g., data sources 123-1 to 123-N. In some implementations, each data source 123 can include user data for users that are signed into a website, application, or other resource of a platform corresponding to the data source 123. In this way, data provided by the user, e.g., user profile data, can be included in the aggregation if permitted by the user. Similarly, data accumulated over multiple sessions of the user with the resource can be included in the aggregation if permitted by the user. As noted above, a user may be provided with controls (e.g., user interface elements with which a user can interact) allowing the user to make an election as to both if and when systems, programs, or features described herein may enable collection of user information and how such information is used.

The user data for a user can include attributes of the users (e.g., provided by the user or inferred), data identifying resources and/or content of resources requested and/or viewed by the user, topics of interest of the user (e.g., provided by the user or inferred based on other user data), search queries (or their topic or category) submitted by the user, digital components with which the user interacted, and/or other appropriate user data. For activities of the user, the user data can include a timestamp that indicates when the activity occurred.

The data anonymizer 124 is configured to apply privacy preserving techniques to the aggregated data to preserve user data privacy. These techniques can include anonymizing the data for each user, e.g., by removing any user identifiers from the data, applying k-anonymity techniques, and/or applying differential privacy techniques to the aggregated data.

The aggregated profile generator 126 is configured to generate an aggregated profile for each aggregation key based on aggregated data after the aggregated data has been processed by the data anonymizer 124. As noted above, an aggregated profile for an aggregation key can include various types of aggregated user data about users for which data is aggregated for the aggregation key, such as user attributes (e.g., confirmed demographic information provided by users and/or inferred demographic information), topics of interest of the users, resources visited by the users and their topics, data identifying search queries submitted by the users, data identifying digital components with which the users interacted, and/or other appropriate data. Such data can be limited to a particular time period, e.g., the past day, week, month, year, and/or other appropriate time period.

The aggregated profile for an aggregation key can include metrics computed by the aggregated profile generator 126. For example, the metrics can include a count of a number of users for which data is being aggregated for the aggregation key that have each possible value for each type of data (e.g., that have a particular topic of interest or attribute in their data), the percentage of users that have that value, and/or other appropriate metrics. In some implementations, the aggregated profile generator 126 can filter the data to only include attributes, topics of interest, resources, etc. that are found in the aggregated data for at least a threshold number of users or for which the count of the number of users is highest (e.g., the top N topics). For example, an aggregated profile can indicate the top N topics of interest for an aggregation key, the top N search queries submitted by the users, and the percentage of users having each user attribute.

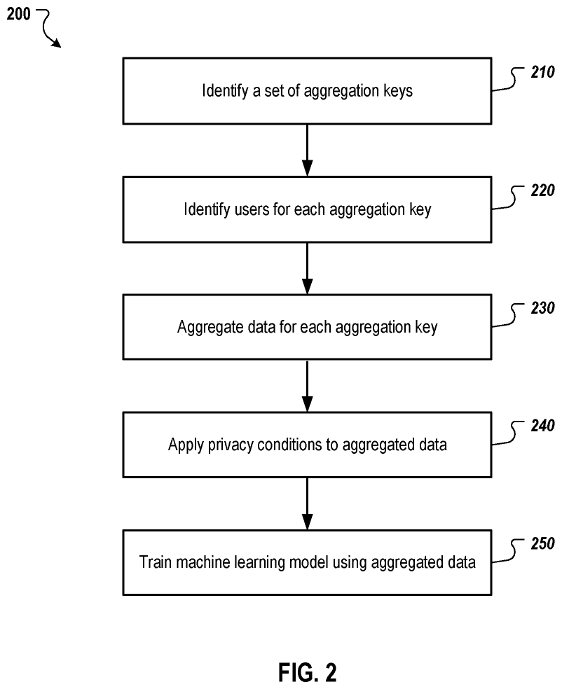

The aggregated profile generator 126 can provide an aggregated report 127 that includes the aggregated profile for each aggregation key that is not filtered by the data anonymizer 124 (as described below) to the model training system 132. The model training system 132 can train a machine learning model 133 to predict data about users using the aggregated profiles and their respective data. The components of the aggregation system 120 and the model training system 132 are described in more detail with reference to FIG. 2.

FIG. 2 is a flow diagram of an example process 200 for aggregating data and training a transfer machine learning model using the aggregated data Operations of the process 200 can be performed by an aggregation system 120 and a model training system 132. Operations of the process 200 can also be implemented as instructions stored on one or more computer readable media, which may be non-transitory, and execution of the instructions by one or more data processing apparatus can cause the one or more data processing apparatus to perform the operations of the process 200.

A set of aggregation keys is identifier (210). For example, as described above, a content platform 130 can provide, to the aggregation system 120, configuration data 121 that defines the aggregation keys for which aggregated profiles are to be generated by the aggregation system 120.

A set of users is identified for each aggregation key (220). The data aggregator 122 can evaluate user data available for multiple users, e.g., in one or more data sources 123, to identify users for each aggregation key. For each aggregation key, the data aggregator 122 can identify, for inclusion in the set of users for the aggregation key, users whose data matches the signals (e.g., contextual signals and/or topics) of the aggregation key. For example, if the signals include a particular resource, the data aggregator 122 can identify users that visited the resource for inclusion in the set of users for the aggregation key Users that did not visit the resource (as determined based on their user data) may not be included in the set of users for the aggregation key.

If an aggregation key includes multiple signals, the data aggregator 122 can identify users whose data matches all signals. For example, if the aggregation key includes a particular topic of interest and a particular URL, the data aggregator 122 may only include, in the set of users for the aggregation key, users that have the topic of interest as one of their interests and visited the particular URL. In some implementations, aggregation keys can include Boolean operators (e.g., AND, OR, NOT) to define combinations of signals for use in identifying users for an aggregation key.

Data is aggregated for each aggregation key (230). For each aggregation key, the data aggregator 122 can aggregate the user data for the set of users identified for that aggregation key. As described above, the configuration data 121 can specify the types of data to be aggregated and how that data is aggregated.

Privacy conditions are applied to the aggregated data (240). The data anonymizer 124 can apply one or more privacy conditions to the aggregated data to preserve the data privacy of each user in the set of users identified for each aggregation key.

In some implementations, the data anonymizer 124 anonymizes the user data for each user by removing any identifying information, such as a user identifier that identifies the user to a platform, contact information (e.g., e-mail address), username, etc.

The data anonymizer 124 can apply k-anonymity techniques to the aggregated data. Using k-anonymity can ensure that the set of users for each aggregation key satisfies (e.g., meets or exceeds) a threshold value. This ensures that the aggregated data for an aggregation key represents at least a threshold number of users such that the data for each individual user in the set of users is protected. For example, absent k-anonymity techniques, a content platform may be able to obtain the data for a particular user that visited their site from a particular location if only one user did so, and the content platform defined an aggregation key for that site and location. Using k-anonymity prevents such malicious attempts to obtain individual user data.

If the number of users in the set of users for an aggregation key does not satisfy the threshold, the data anonymizer 124 can remove the data for that aggregation key or perform a fallback technique. The fallback technique can be to remove one or more of the signals from the aggregation key or to broaden one or more of the signals. For example, if the users have to match all signals of an aggregation key to be included in the set of users for the aggregation key, removing a signal can result in more users being eligible for inclusion in the set of users. Similarly broadening a signal can result in more eligible users. One example of broadening a signal is to use a higher level domain name for a URL, e.g., to go from example.com/flowers/roses to example.com/flowers or to example.com. Another example of broadening is broadening a topic, e.g., from golf to outdoor sports.

The data anonymizer 124 can be configured to apply a fallback technique one or more times until an aggregation key that does not originally satisfy the k-anonymity threshold does satisfy the threshold. If the modified aggregation key satisfies the threshold, the data anonymizer 124 can update the aggregation key to match the modified aggregation key and interact with the data aggregator 122 to aggregate user data for a set of users that match the modified aggregation key.

In some implementations, the data anonymizer 124 applies differential privacy noise to the aggregated data for each (or at least some) aggregation keys. Applying differential privacy noise can include adjusting the number of users in the set of users for the aggregation, adjusting a count of a number of users in the set of users that have a particular attribute, topic of interest, or other particular value for a data type. This can mask the actual number of users for each of these metrics.

A machine learning model is trained using the aggregated data for each aggregation key for which the aggregated data passed the privacy conditions (250). The model training system 132 can train a machine learning model to output predicted data about a user based on input signals, e.g., input contextual signals of a digital component request.

In some implementations, the model training system 132 uses transfer learning to train the machine learning model. For example, the aggregated data used to train the machine learning model can be obtained for users of a first platform and the trained machine learning model can be used to predict data about users (e.g., topics of interest and/or attributes) of a second platform different from the first platform and for which different types of data may be available. Transfer learning involves techniques for using a trained machine learning model that is trained for one task to perform a different task. The model training system 132 can use model transfer techniques, data transfer techniques, or a hybrid of model and data transfer techniques.

Using model transfer techniques, the model training system 132 can train a machine learning model to predict data about users using the aggregated data for the aggregation keys. As the information about the users is known and included in the aggregated data, the training can include supervised training in which the user data (e.g., topics of interest and/or attributes) is used as labels in the training set and used to test the machine learning model. The features used during training can include the signals (e.g., contextual signals and/or topics) of the aggregation keys as these are the signals that would be provided as input to the trained machine learning model. The model training system 132 can then transfer the trained machine learning model to the second platform for use in outputting inferences (e.g., in the form of predicted data about users and/or score for each prediction).

In data transfer techniques, the aggregated data be used as a label provider or additional feature for training a machine learning model for the second platform. As a label provider, the aggregation key can be the label and the features of the set of users for each aggregation key can be the features for that label. As an example, the labels (and aggregation keys) for the machine learning model can include URLs for resources, e.g., web pages, and the features can include various user features (e.g., user attributes and/or user interests) for users of the first platform. The aggregated data can include, for each aggregation key and therefore each label, values for the user features of the users of the first platform.

The model training system 132 can train a machine learning model to generate labels for features of users of a second platform using the labeled data for the users of the first platform. For example, the model training system 132 can use the labels and features of the data for the first platform in combination with any labels and features of the second platform. In some cases, the first platform and the second platform can include matching labels (e.g., URLs) and/or matching features that correspond to the labels. In other cases, all of the labels and/or features may not match between the two platforms. In such cases, the model training system 132 can map non-matching labels and/or features of the first platform with labels and//or features of the second platform. The model training system 132 can also train the machine learning model using matching features and labels and non-matching features and labels.

The model training system 132 can train the machine learning model by splitting the label and feature data into training and testing sets. The model training system 132 can train the machine learning model using the training set and then test the model using the testing set.

In the hybrid approach, the model training system 132 can first train a machine learning model using the aggregated data for the aggregation keys. This machine learning model can be used as a warm start for the data transfer approach. The model training system 132 can then retrain or update the machine learning model using data of the second platform. The data of the second platform can be used to fine tune the model. The data of the second platform can be used to fine tune the model for use with input data of the second platform. For example, the model training system 132 can determine, based on the aggregated data for the first platform, that users that view resources having a particular aggregation key are more likely to have a particular interest than another interest. The model training system 132 can use this information to fine tune the machine learning model if the machine learning model is configured to use a user interest and/or URL as an input or to output a probability that a user is interested in a particular topic based on an input URL. In other words, the model training system 132 can use insights from the aggregated data in combination with features and/or labels available at the second platform for fine tune the model for use by the second platform. This fine tuning can include updating weights of the machine learning model, increasing an importance of certain features, etc.

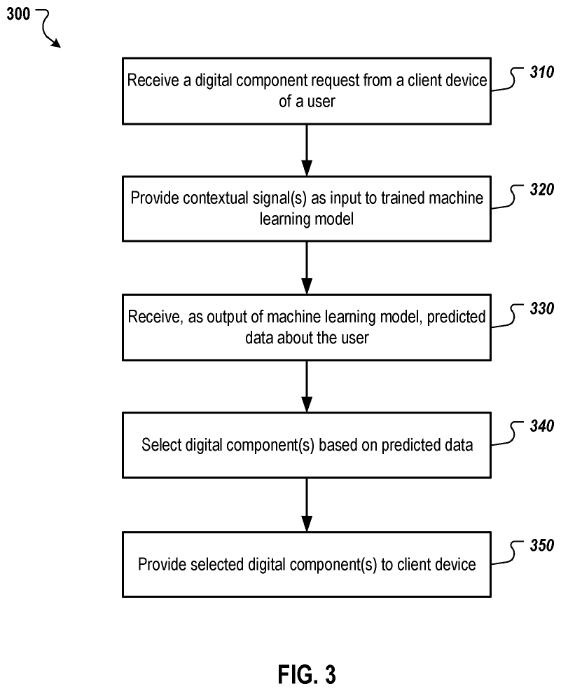

FIG. 3 is a flow diagram of an example process 300 for selecting a digital component using a machine learning model and providing the digital component for presentation at a client device. Operations of the process 300 can be performed by a digital component selection system 134. Operations of the process 300 can also be implemented as instructions stored on one or more computer readable media, which may be non-transitory, and execution of the instructions by one or more data processing apparatus can cause the one or more data processing apparatus to perform the operations of the process 300.

A digital component request is received from a client device of a user (310). The digital component request can include a set of contextual signals that describe an environment in which a selected digital component will be presented. The contextual signals can include any of the contextual signals described in this document, e.g., resource locator, location, type of device, etc.

The contextual signals are provided as input to a machine learning model (320). The machine learning model can be trained to output, based on input contextual signals, predicted data about the user of the client device. For example, the machine learning model can be trained to output predicted topics of interest and/or attributes about the user and optionally scores for each topic and/or attribute, as described above. In particular, the machine learning model can be configured to output, for each topic of interest and/or attribute, a probability that the user is interested in that topic and/or has that attribute.

Predicted data about the user of the client device is received as an output of the trained machine learning model (330). This data can include the probability for each interest and/or attribute.

One or more digital components are selected for the user based on the predicted data about the user (340). For example, the digital component selection system 134 can provide the predicted data about the user as an input to a machine learning model that is trained to output scores for digital components based on the predicted user data. In another example, the digital component selection system 134 can evaluate a set of rules based on the predicted user data to select a digital component.

For example, each digital component can include distribution criteria that identifies a set of topics, attributes, and/or contextual data for which the digital component is eligible for distribution and/or a selection parameter that indicates an amount that a provider of the digital component is willing to provide in exchange for the presentation of the digital component in response to requests corresponding to the distribution criteria, e.g., requests for which the contextual data of the request matches the contextual data of the distribution criteria and/or the interests and/or topics for which the probability is high (e.g, satisfies a threshold by meeting or exceeding the threshold). The digital component selection system 134 can evaluate the distribution criteria of the digital components to identify those that are eligible given the contextual data and/or user interest and/or attribute probabilities. The digital component selection system 134 can then select, from the eligible digital components, one or more digital components based on their selection parameters.

The one or more digital components are sent to the client device for presentation to the user (350). The digital component selection system 134 can send, to the client device, the digital component(s) or data that enables the client device to download the digital component(s) from a network server. The client device can then present the digital component(s) to the user.

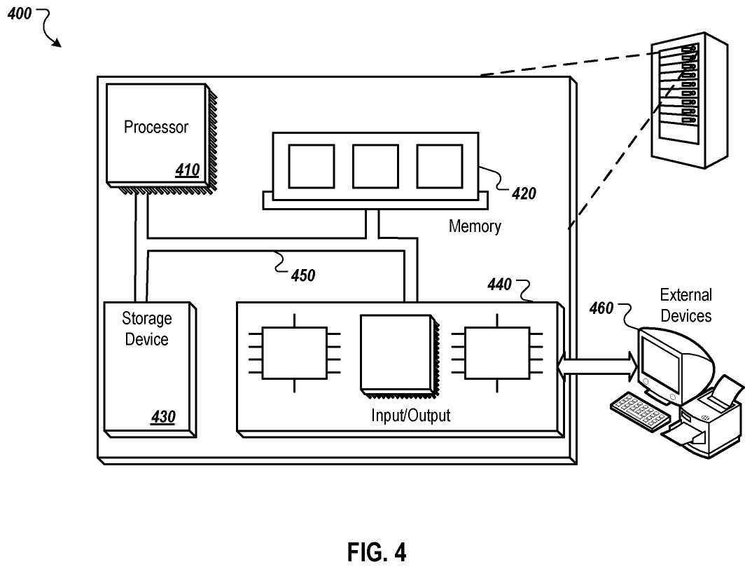

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 460, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, from a client device of a user, a digital component request comprising one or more contextual signals that describe an environment in which a selected digital component will be presented;
providing the one or more contextual signals as input to a trained machine learning model that is trained to output, based on input contextual signals, predicted data about the user, wherein the trained machine learning model is trained using a set of aggregated data comprising, for each of a set of aggregation keys, aggregated data for a plurality of users having electronic resource views that match the aggregation key;
receiving, as an output of the trained machine learning model, the predicted data about the user;
selecting one or more digital components based on the predicted data about the user; and
sending, to the client device, the one or more digital components for presentation at the client device.

2. The computer-implemented method of claim 1, wherein the predicted data about the user comprises at least one of (i) one or more interests of the user or (ii) one or more attributes of the user.

3. The computer-implemented method of claim 1, wherein the one or more contextual signals comprise (i) at least a portion of a resource locator for an electronic resource, (ii) a type of the client device, or (iii) a geographic location of the client device.

4. The computer-implemented method of claim 1, wherein each aggregation key comprises at least one contextual signal and/or at least one topic of interest.

5. The computer-implemented method of claim 4, wherein the at least one contextual signal comprises (i) at least a portion of a resource locator for an electronic resource, (ii) a type of device, or (iii) a geographic location.

6. The computer-implemented method of claim 4, further comprising generating the set of aggregated data, including, for each aggregation key:
identifying the plurality of users having electronic resource views that match the aggregation key;
identifying a set of data for each of the plurality of users; and
aggregating the set of data for each of the plurality of users.

7. The computer-implemented method of claim 6, wherein the set of data for each user comprises (i) one or more interests of the user or (ii) attributes of the user.

8. The computer-implemented method of claim 6, wherein generating the set of aggregated data comprises identifying the set of aggregation keys, including selecting, for inclusion in the set of aggregation keys, only aggregation keys for which the plurality of users satisfies a k-anonymity condition.

9. The computer implemented method of claim 6, further comprising applying differential privacy to the set of aggregated data by adjusting a count of users in the plurality of users for one or more aggregation keys.

10. The computer-implemented method of claim 1, further comprising training the trained machine learning model using a transfer learning technique.

11. The computer-implemented method of claim 10, wherein training the trained machine learning model comprises adding the set of aggregated data as labels or features of the trained machine learning model.

12. A system comprising:
one or more processors; and
one or more storage devices storing instructions that, when executed by the one or more processors, cause the one or more processors to perform operating comprising:
receiving, from a client device of a user, a digital component request comprising one or more contextual signals that describe an environment in which a selected digital component will be presented;
providing the one or more contextual signals as input to a trained machine learning model that is trained to output, based on input contextual signals, predicted data about the user, wherein the trained machine learning model is trained using a set of aggregated data comprising, for each of a set of aggregation keys, aggregated data for a plurality of users having electronic resource views that match the aggregation key;
receiving, as an output of the trained machine learning model, the predicted data about the user;
selecting one or more digital components based on the predicted data about the user; and
sending, to the client device, the one or more digital components for presentation at the client device.

13. The system of claim 12, wherein the predicted data about the user comprises at least one of (i) one or more interests of the user or (ii) one or more attributes of the user.

14. The system of claim 12, wherein the one or more contextual signals comprise (i) at least a portion of a resource locator for an electronic resource, (ii) a type of the client device, or (iii) a geographic location of the client device.

15. The system of claim 12, wherein each aggregation key comprises at least one contextual signal and/or at least one topic of interest.

16. The system of claim 15, wherein the at least one contextual signal comprises (i) at least a portion of a resource locator for an electronic resource, (ii) a type of device, or (iii) a geographic location.

17. The system of claim 16, wherein the operations comprise generating the set of aggregated data, including, for each aggregation key:
identifying the plurality of users having electronic resource views that match the aggregation key;
identifying a set of data for each of the plurality of users; and
aggregating the set of data for each of the plurality of users.

18. The system of claim 17, wherein the set of data for each user comprises (i) one or more interests of the user or (ii) attributes of the user.

19. The system of claim 17, wherein generating the set of aggregated data comprises identifying the set of aggregation keys, including selecting, for inclusion in the set of aggregation keys, only aggregation keys for which the plurality of users satisfies a k-anonymity condition.

20. A non-transitory computer readable medium carrying instructions that, when executed by one or more processors, cause the one or more processors to perform operations comprising:
receiving, from a client device of a user, a digital component request comprising one or more contextual signals that describe an environment in which a selected digital component will be presented;
providing the one or more contextual signals as input to a trained machine learning model that is trained to output, based on input contextual signals, predicted data about the user, wherein the trained machine learning model is trained using a set of aggregated data comprising, for each of a set of aggregation keys, aggregated data for a plurality of users having electronic resource views that match the aggregation key;
receiving, as an output of the trained machine learning model, the predicted data about the user;
selecting one or more digital components based on the predicted data about the user; and
sending, to the client device, the one or more digital components for presentation at the client device.
